(19) United States
(12) Patent Application Publication
(10) Pub. No.: US 2018/0038071 A1
(43) Pub. Date: Feb. 8, 2018

(54) APPARATUS FOR ENTRENCHING A FLEXIBLE ELONGATE MEMBER, SUCH AS A ROPE, CABLE OR PIPE

(71) Applicant: AFT TRENCHERS LIMITED, Sudbury (GB)

(72) Inventor: Harry Maria Jurgens, Sudbury (GB)

(73) Assignee: AFT TRENCHERS LIMITED, Sudbury (GB)

(21) Appl. No.: 15/550,701

(22) PCT Filed: Dec. 8, 2015
(86) PCT No.: PCT/GB2015/053756

§ 371 Date: Aug. 11, 2017

(30) Foreign Application Priority Data
Feb. 12, 2015 (GB) 1502351.8

(51) Int. Cl. E02F 5/10; H02G 1/06; H02G 9/02; E02F 5/12

(52) U.S. Cl. CPC E02F 5/103; E02F 5/12; H02G 1/06; H02G 9/02

(57) ABSTRACT

The present invention provides apparatus (10) and method for entrenching a flexible elongate member (18) in the ground (11). The apparatus comprises a downwardly extending blade (12) having a forward facing edge for parting the ground, the apparatus thereby forming a trench in the ground as the apparatus is moved forwards. It also comprises an aggregate dispenser (14) having an opening (15) located rearwardly of the blade, the apparatus thereby filling the trench with aggregate as the apparatus moves forward. A guide (16, 22) for the flexible elongate member (18) extends through the apparatus such that the member exits the apparatus rearwardly at or near a lower end of the blade. The apparatus thereby embeds the member in the aggregate in the trench as the apparatus is moved forwards along the ground in use.

The present invention relates to an apparatus for entrenching a flexible elongate member, such as a rope, cable or pipe, in the ground. The present invention also relates to a method of entrenching a flexible elongate member in the ground.

In order to improve ground drainage, it is known to provide narrow sand-filled trenches in the ground. These sand-filled trenches act as conduits for water, allowing the water to drain away from a saturated area of ground. It is also known to place water absorbing ropes in the ground. Water from the saturated area of ground can be absorbed through the rope and can drain away. It is also extremely well known to place cables or pipes in the ground, for example so as to provide utility services. However, it can be difficult and time-consuming to place ropes, cables or pipes in the ground without disturbing or “heaving” the surrounding ground, and the resultant uneven ground can be particularly undesirable at some sporting venues, such as a golf courses, football pitches, etc.

It is therefore a principal aim of this invention to provide an apparatus that can place a flexible elongate member in the ground without significantly disturbing the surrounding ground.

Thus, according to an aspect of the present invention there is provided an apparatus for entrenching a flexible elongate member in the ground, the apparatus comprising: a downwardly extending blade having a forward facing edge for parting the ground, the apparatus thereby forming a trench in the ground as the apparatus is moved forwards along the ground in use; an aggregate dispenser having an opening located rearwardly of the blade, the apparatus thereby filling the trench with aggregate as the apparatus is moved forwards along the ground in use; and a guide for guiding a flexible elongate member through the apparatus such that the member exits the apparatus rearwardly at or near a lower end of the blade, the apparatus thereby embedding the member in the aggregate in the trench as the apparatus is moved forwards along the ground in use.

As will be appreciated from the above, the present invention provides an apparatus that can place a flexible elongate member, such as a rope, cable or pipe, in the ground without significantly disturbing the surrounding ground. In particular, since the blade merely parts the ground, there is little ground disturbance or ground heave when forming the trench. Furthermore, since the trench can simultaneously be filled with consolidated aggregate, such as sand or soil, the ground remains substantially even once the member is entrenched in the ground. The aggregate can also provide a suitable medium for grass to regrow over the entrenched member.

In some embodiments, the elongate member comprises a drainage rope, such as a rope having a core for draining water. In other embodiments, the elongate member may comprise a cable. The cable may be for a utility supply (e.g. a telecommunications cable or electricity cable), for underground heating (e.g. a resistive electrical cable), or a perimeter cable (e.g. for a robotic lawnmower). In other embodiments, the elongate member may comprise a pipe, such as a water irrigation pipe. In some embodiments, more than one elongate member (or more than one type of elongate member) may simultaneously be entrenched by the apparatus in use.

In preferred embodiments, the horizontal cross-section of the blade is substantially V-shaped, with the base of the V-shape being at or towards the forward facing edge of the blade. The width of the blade, and therefore the width of the trench formed thereby, may be in the range 10-40 mm (e.g. approximately 25 mm). The working part of the blade, and therefore the depth of the trench formed thereby, may be in the range 100 mm-400 mm (e.g. approximately 250 mm). The apparatus may further comprise means for oscillating the blade forwards and rearwards and/or upwards and downwards (e.g. in a substantially elliptical or circular motion) as the apparatus is moved forwards along the ground in use. These embodiments can assist in forming the trench, in consolidating/compacting the aggregate as it is deposited, and/or in reducing the amount of ground heave.

In preferred embodiments, the opening in the aggregate dispenser is adjacent the lower end and/or rearward side of the blade. Thus, the location at which the member and aggregate meet is preferably adjacent the lower end and/or rearward side of the blade. The member and the aggregate preferably remain separate up until that location.

In preferred embodiments, the guide comprises a blade conduit for guiding the member through the blade, the blade conduit being arranged such that the member exits the blade rearwardly at or near the lower end of the blade. These embodiments allow the member to be suitably entrenched without the need for the member to follow a tortuous route. However, in other embodiments, the guide may comprise a blade conduit for guiding the member along the outside of the blade.

In preferred embodiments, the apparatus further comprises a hopper for holding the aggregate, the hopper providing aggregate to the aggregate dispenser as the apparatus is moved forwards along the ground in use. The hopper is preferably located above the aggregate dispenser, preferably such that the aggregate can be provided to the aggregate dispenser under the force of gravity alone. The guide may further comprise an upper conduit for guiding the member downwardly from an upper part of the apparatus. The upper conduit preferably guides the member downwardly from above the hopper and/or preferably guides the member to the blade conduit.

In preferred embodiments, the apparatus further comprises a member dispenser for proving the member to the guide as the apparatus is moved forwards along the ground in use. The member dispenser may comprise, for example, a reel on which the member is wound or a container within which the member is suitably coiled. The member dispenser may be located in an upper part of the apparatus, preferably above the hopper if provided.

In preferred embodiments, the apparatus further comprises a coupling for attaching the apparatus to a vehicle such that the vehicle can move (e.g. pull) the apparatus forwards in use. The vehicle may be, for example, a tractor. In other embodiments, the apparatus may form an integral part of a vehicle.

In preferred embodiments, the apparatus further comprises one or more (e.g. two or more) wheels on which the apparatus can be moved forwards in use. The apparatus preferably comprises a roller for consolidating/compacting the aggregate in the trench as the apparatus is moved forwards along the ground in use. In some embodiments, the one or more wheels act as the roller.

According to another aspect of the present invention there is provided a method of entrenching a flexible elongate member in the ground using an apparatus as described herein, the method comprising moving the apparatus forwards such that the member is embedded in the aggregate in the trench as the apparatus is moved forwards along the ground.

By way of example only, embodiments of the invention will now be described in detail with reference being made to the accompanying drawings in which:

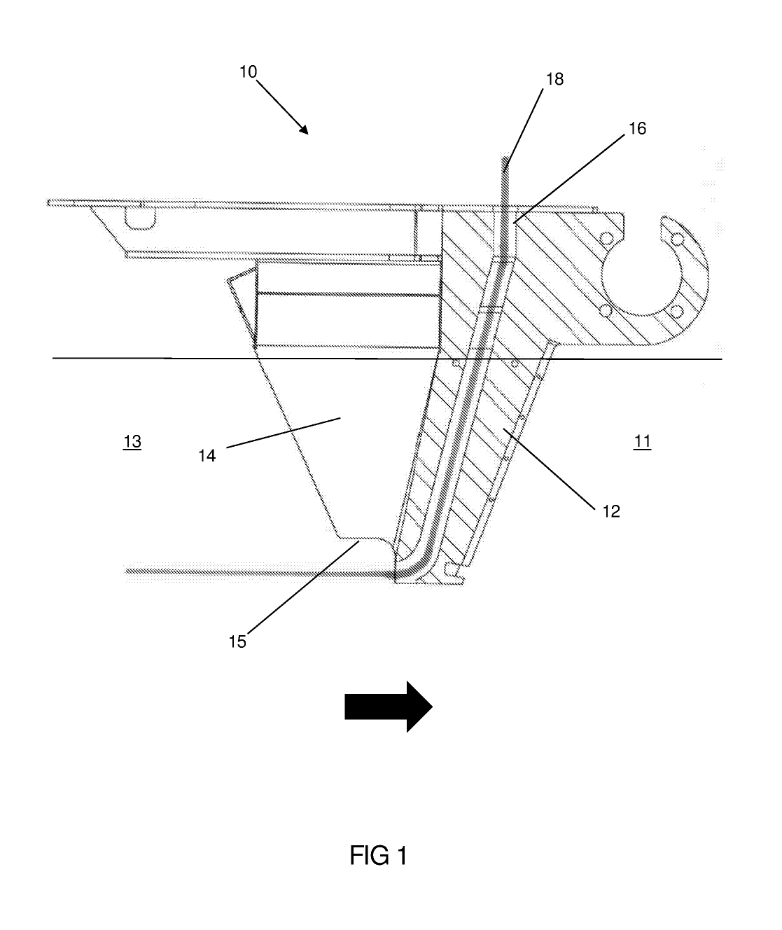

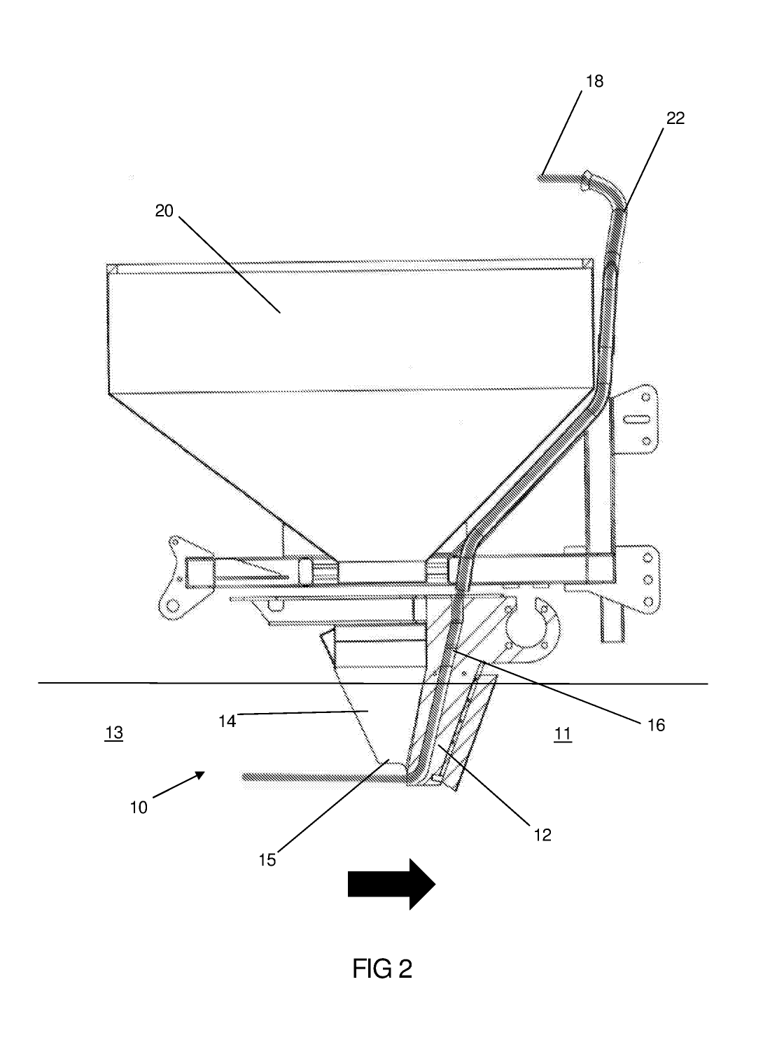

FIGS. 1 and 2 show an entrenching apparatus according to an embodiment of the present invention;

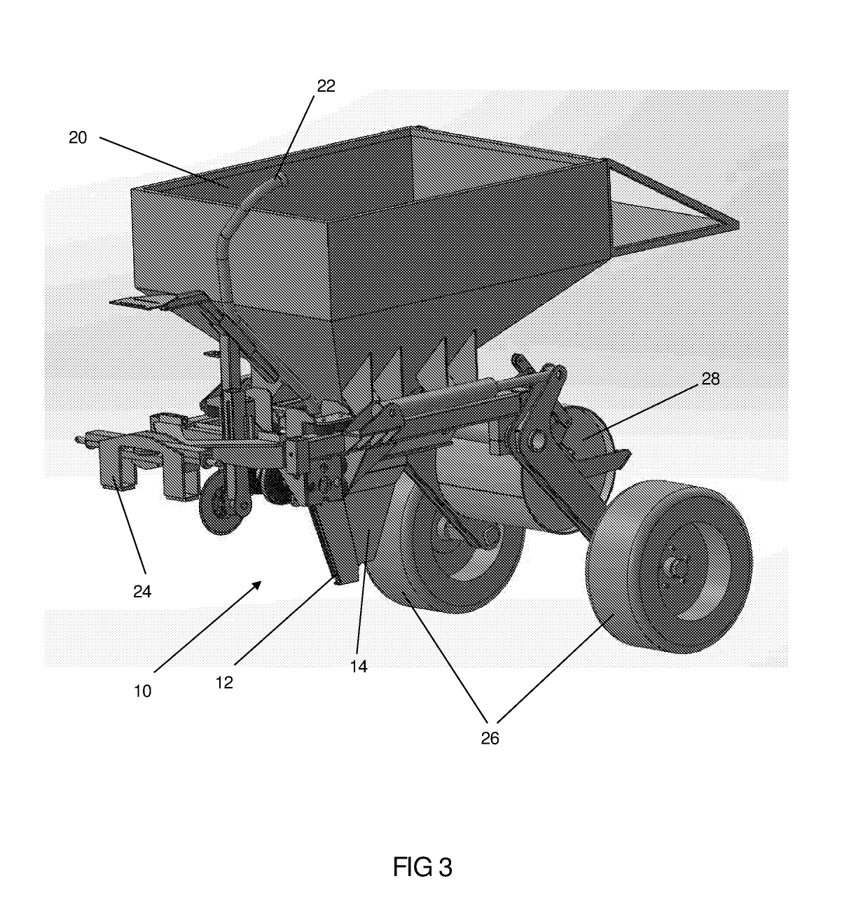

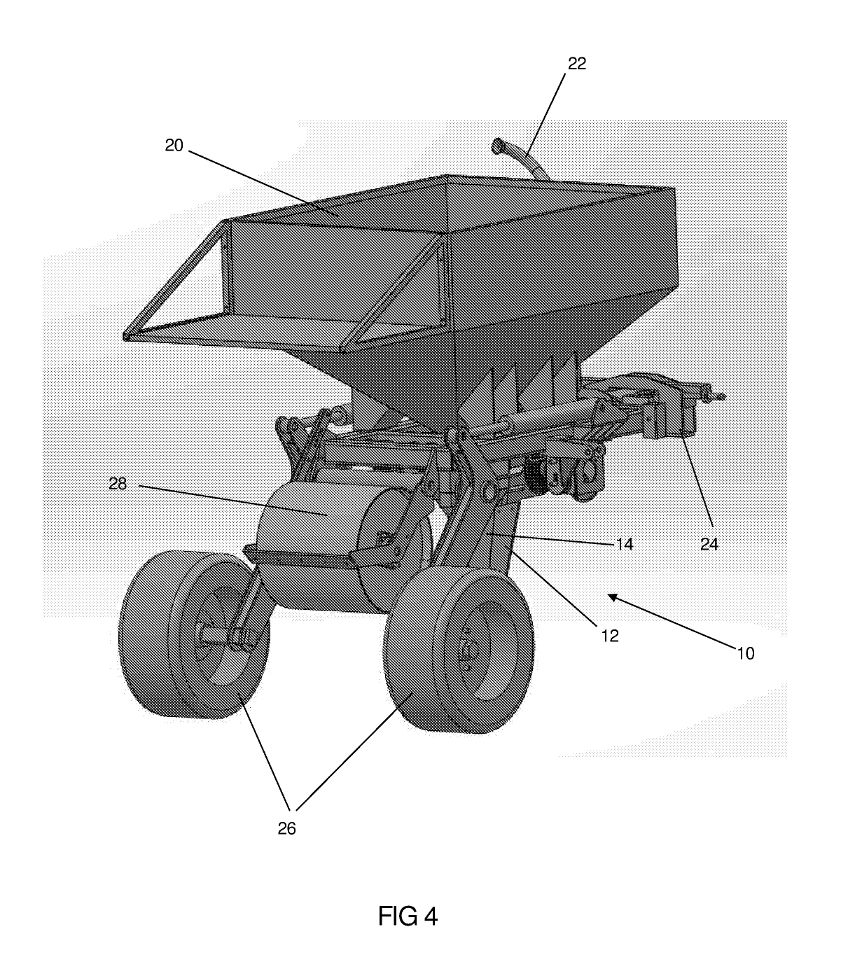

FIGS. 3 and 4 show further details for the entrenching apparatus of FIGS. 1 and 2; and

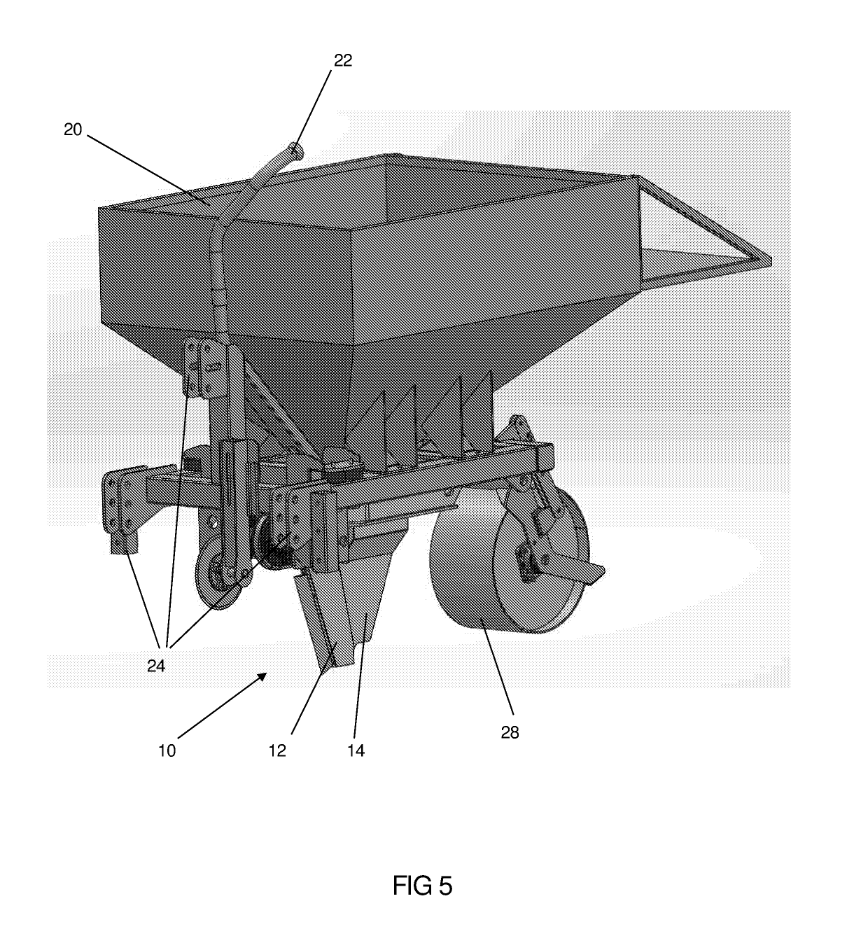

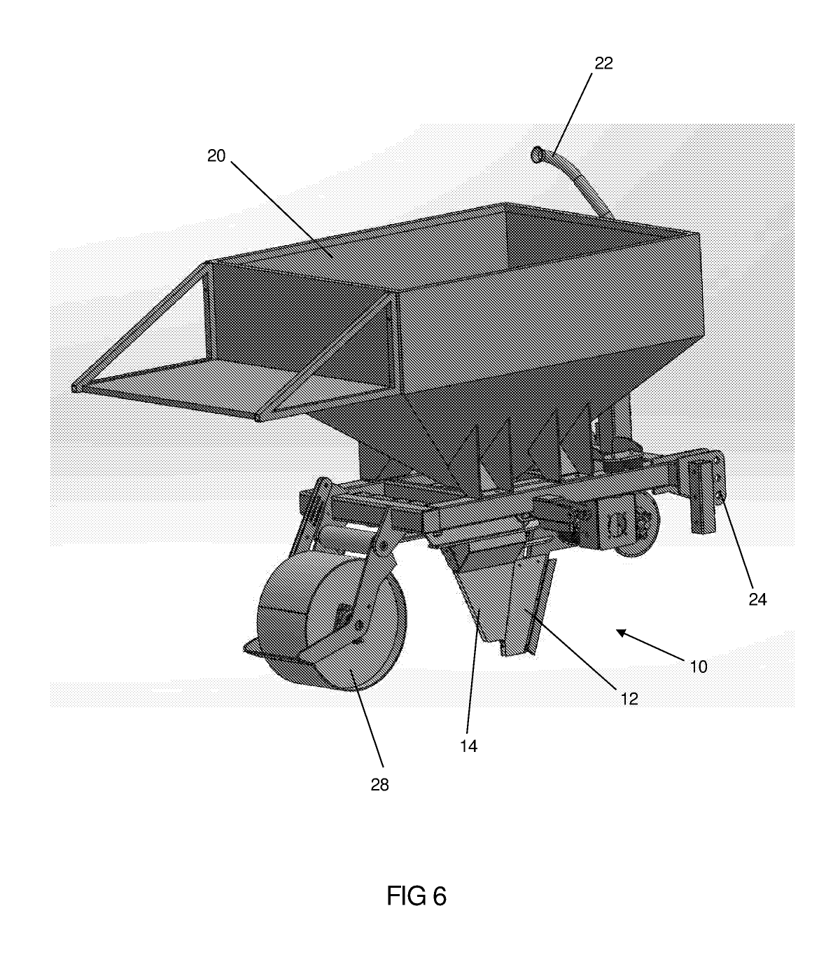

FIGS. 5 and 6 show alternative further details for the entrenching apparatus of FIGS. 1 and 2.

Reference will initially be made to FIGS. 1 and 2, which show an apparatus 10 for entrenching a flexible elongate member in the ground 11. In this embodiment, the member is a rope 18 having a water-draining core, although the following description could equally apply to other types of rope, cables or pipes.

As is shown in FIGS. 1 and 2, the apparatus 10 comprises a downwardly extending V-shaped blade 12 that has a forward facing edge for parting the ground 11 as the apparatus 10 is moved forwards (i.e. in the direction shown by the arrow). As the apparatus is moved forwards, the blade 12 oscillates forwards/rearwards and upwards/downwards so as to assist in parting the ground 11. In this embodiment, the blade 12 is 25 mm wide and has a working depth of 250 mm. The blade 12 therefore forms a trench 13 that is substantially 25 mm wide and 250 mm deep.

The apparatus 10 further comprises an aggregate dispenser 14 having an opening 15 located rearwardly of the blade 12. The aggregate dispenser 14 fills the trench 13 with aggregate as the apparatus 10 is moved forwards. The above-mentioned oscillation of the blade 12 can also assist in consolidating/compacting the aggregate as it is deposited. The aggregate dispenser 14 is provided with aggregate from a hopper 20 that is positioned above the aggregate dispenser 14. In this embodiment, the aggregate used is sand, although the description herein could equally apply to other types of aggregate.

The apparatus 10 further comprises a guide in the form of a blade conduit 16 that guides the rope 18 through the blade 12. The rope 18 exits the blade 10 rearwardly near a lower end of the blade 12 so as to occupy the length of trench 13. In this embodiment, the guide further comprises an upper conduit 22 for guiding the rope 18 from a reel (not shown) on the upper part of the apparatus 10 downwardly to the blade conduit 16.

Thus, as the apparatus 10 is moved forwards, the blade 12 forms a trench 13 in the ground 11, the rope 18 is fed into the trench 13, and the trench 13 is filled with aggregate thereby embedding the rope 18 in the aggregate in the trench 13.

Referring now to FIGS. 3 and 4, the apparatus 10 may further comprise a coupling 24 for attaching the apparatus 10 to a vehicle, such as a tractor. This allows the vehicle to pull the apparatus 10 forwards. In the embodiment of FIGS. 3 and 4, the apparatus 10 further comprises two suspension-mounted wheels 26 on which the apparatus 10 can be pulled forwards. The apparatus 10 further comprises a roller 28 for consolidating/compacting the aggregate in the trench 13 as the apparatus 10 is moved forwards along the ground 11.

Referring now to FIGS. 5 and 6, the apparatus 10 may again comprise a coupling 24 for attaching the apparatus 10 to a vehicle. However, in the embodiment of FIGS. 5 and 6, the apparatus 10 comprises a consolidating/compacting roller 28 that also acts as a single wheel for the apparatus 10.

1. An apparatus for entrenching a flexible elongate member in the ground, the apparatus comprising:
a downwardly extending blade having a forward facing edge for parting the ground, the apparatus thereby forming a trench in the ground as the apparatus is moved forwards along the ground in use;
an aggregate dispenser having an opening located rearwardly of the blade, the apparatus thereby filling the trench with aggregate as the apparatus is moved forwards along the ground in use; and
a guide for guiding a flexible elongate member through the apparatus such that the member exits the apparatus rearwardly at or near a lower end of the blade, the apparatus thereby embedding the member in the aggregate in the trench as the apparatus is moved forwards along the ground in use.

2. An apparatus as claimed in claim 1, wherein the elongate member is a rope, cable or pipe.

3. An apparatus as claimed in claim 1, wherein the horizontal cross-section of the blade is substantially V-shaped, with the base of the V-shape being at or towards the forward facing edge of the blade.

4. An apparatus as claimed in claim 1, further comprising means for oscillating the blade forwards and rearwards and/or upwards and downwards as the apparatus is moved forwards along the ground in use.

5. An apparatus as claimed in claim 1, wherein the guide comprises a blade conduit for guiding the member through the blade, the blade conduit being arranged such that the member exits the blade rearwardly at or near the lower end of the blade.

6. An apparatus as claimed in claim 1, further comprising a hopper for holding the aggregate, the hopper providing aggregate to the aggregate dispenser as the apparatus is moved forwards along the ground in use.

7. An apparatus as claimed in claim 1, wherein the guide further comprises an upper conduit for guiding the member downwardly from an upper part of the apparatus.

8. An apparatus as claimed in claim 1, further comprising a member dispenser for proving the member to the guide as the apparatus is moved forwards along the ground in use.

9. An apparatus as claimed in claim 1, further comprising a coupling for attaching the apparatus to a vehicle such that the vehicle can move the apparatus forwards in use.

10. An apparatus as claimed in claim 1, further comprising one or more wheels on which the apparatus can be moved forwards in use.

11. An apparatus as claimed in claim 1, further comprising a roller for consolidating/compacting the aggregate in the trench as the apparatus is moved forwards along the ground in use.

12. A method of entrenching a flexible elongate member in the ground using an apparatus as claimed in claim 1, the method comprising moving the apparatus forwards such that the member is embedded in the aggregate in the trench as the apparatus is moved forwards along the ground.
